(19) United States
(12) Patent Application Publication
(10) Pub. No.: US 2014/0138452 A1
(43) Pub. Date: May 22, 2014

(54) System And Method For Heating The Passenger Compartment Of A Fuell Cell-Powered Vehicle

(71) Applicant: GM GLOBAL TECHNOLOGY OPERATIONS LLC, Detroit, MI (US)

(72) Inventors: Volker Formanski, Wiesbaden (DE); Bram Peters, Mainz Kostheim (DE); Remy Fontaine, Wiesbaden (DE)

(73) Assignee: GM GLOBAL TECHNOLOGY OPERATIONS LLC, Detroit, MI (US)

(21) Appl. No.: 13/681,943

(22) Filed: Nov. 20, 2012

(51) Int. Cl. B60H 1/22; B60H 1/00

(52) U.S. Cl. CPC B60H 1/22; B60H 1/00385
USPC 237/12.3 R; 165/202

(57) ABSTRACT

A system for conditioning the air in a passenger compartment of a fuel cell-powered vehicle is provided, the system including a metal hydride buffer and a hydrogen source, wherein the metal hydride buffer reversibly adsorbs and desorbs hydrogen gas. The change in temperature associated with adsorption or desorption of the hydrogen gas by the metal hydride buffer is thermally communicated to the passenger compartment, thereby conditioning the air therein. Desorbed hydrogen gas is fed back to the fuel cell to power the vehicle. Also provided are a vehicle having a system for conditioning air in a passenger compartment that employs the change in temperature resulting from the adsorption and desorption of hydrogen gas by the metal hydride buffer and methods for heating or cooling a passenger compartment of a fuel cell-powered vehicle.

### BACKGROUND OF THE INVENTION

The present invention relates generally to an apparatus for a hydrogen fueled vehicle, and more particularly to a hydrogen fueled vehicle that employs off-heat from the charging and discharging of a metal hydride buffer to heat the vehicle passenger compartment without usage of electrical energy and without loss of hydrogen by oxidation. Even more particularly, the present invention relates to a hydrogen fueled vehicle using a fuel cell system to produce electric power for vehicle propulsion or for vehicle auxiliaries.

Electrochemical conversion cells, commonly referred to as fuel cells, produce electrical energy by processing reactants, for example, through the oxidation of hydrogen with oxygen in air. Electric power is provided to an electric motor for vehicle propulsion. The only byproducts produced by such a system are pure water and off-heat. The off heat is generally rejected to the environment by virtue of a liquid coolant loop and a typical automotive radiator. Alternatively, the heater core may be connected to the coolant loop to provide the fuel cell off-heat to the cabin at the request of the passenger. Hydrogen is a very attractive fuel because it is clean and it can be used to produce electricity efficiently in a fuel cell. The automotive industry has expended significant resources in the development of hydrogen fuel cells as a source of power for vehicles. Vehicles powered by hydrogen fuel cells would be more efficient and generate fewer emissions than today's vehicles employing internal combustion engines.

In a typical fuel cell system, hydrogen or a hydrogen-rich gas is supplied as a reactant through a flowpath to the anode side of a fuel cell while oxygen (such as in the form of atmospheric oxygen) is supplied as a reactant through a separate flowpath to the cathode side of the fuel cell. Catalysts, typically in the form of a noble metal such as platinum, are placed at the anode and cathode to facilitate the electrochemical conversion of the reactants into electrons and positively charged ions (for the hydrogen) and negatively charged ions (for the oxygen). In one well-known fuel cell form, the anode and cathode may be made from a layer of electrically-conductive gaseous diffusion media (GDM) material onto which the catalysts are deposited to form a catalyst coated diffusion media (CCDM). An electrolyte layer separates the anode from the cathode to allow the selective passage of ions to pass from the anode to the cathode while simultaneously prohibiting the passage of the generated electrons, which instead are forced to flow through an external electrically-conductive circuit (such as a load) to perform useful work before recombining with the charged ions at the cathode. The combination of the positively and negatively charged ions at the cathode results in the production of non-polluting water as a byproduct of the reaction. In another well-known fuel cell form, the anode and cathode may be formed directly on the electrolyte layer to form a layered structure known as a membrane electrode assembly (MEA).

One type of fuel cell, called the proton exchange membrane (PEM) fuel cell, has shown particular promise for vehicular and related mobile applications. The electrolyte layer of a PEM fuel cell is in the form of a solid proton-transmissive membrane (such as a perfluorosulfonic acid membrane, a commercial example of which is Nafion™). Regardless of whether either of the above MEA-based approach or CCDM-based approach is employed, the presence of an anode separated from a cathode by an electrolyte layer forms a single PEM fuel cell; many such single cells can be combined to form a fuel cell stack, increasing the power output thereof. Multiple stacks can be coupled together to further increase power output.

Porous materials, and in particular certain metal alloys, adsorb hydrogen gas under suitable temperature and pressure conditions and have been explored for use in hydrogen storage in fuel cell systems. The process of charging such metal alloys with hydrogen gas to produce metal hydrides is a reversible process. Adsorption of hydrogen gas by the metal hydride material generates heat (exothermic reaction); whereas desorption of hydrogen gas from the metal hydride material consumes heat (endothermic reaction). The adsorption or desorption of hydrogen is dependent on hydrogen pressure and temperature, and thus pressure and temperature can be employed to control the charging or discharging of the metal hydride material.

A practical challenge for fuel cell-powered vehicles is the conditioning of cabin air flow. In particular, at the onset of use and while the fuel cell system is first heating up, there is insufficient off-heat available to heat the air flow to the vehicle cabin. A need exists for a fuel cell system that supports cabin heating as soon as fuel cell use is initiated (at vehicle start), with minimal additional burden on fuel economy and without loss of hydrogen by oxidation.

### SUMMARY OF THE INVENTION

In view of the above and other problems of the systems and technologies, it is an object of the disclosure to provide a fuel cell-powered vehicle that takes advantage of the generation of heat produced by the adsorption of hydrogen under pressure by a metal hydride buffer to enable feedback to the anode loop of the fuel system and heat a vehicle cabin without usage of electrical energy and without loss of hydrogen by oxidation.

In one embodiment, a system for heating air in a passenger compartment of a fuel cell-powered vehicle is provided, the system comprising a metal hydride buffer in fluid communication with a hydrogen source and an anode of a fuel cell, wherein the metal hydride buffer is configured to adsorb a hydrogen charge gas from the hydrogen source and desorb a hydrogen discharge gas to the anode; and a heat exchange loop in thermal communication with the metal hydride buffer and the passenger compartment, whereby heat produced by adsorption of the hydrogen charge gas by the metal hydride buffer is thermally communicated to the heat exchange loop and transferred to the passenger compartment, thereby heating the air therein.

In another embodiment, a vehicle is provided, the vehicle comprising a source of motive power comprising at least one fuel cell; a fuel supply system coupled to the source of motive power such that operation of the fuel supply system contributes to the turning of at least one wheel of said vehicle through the source of motive power, the fuel supply system comprising: a hydrogen source for providing a hydrogen charge gas; a metal hydride buffer in fluid communication with the hydrogen source and an anode of the at least one fuel cell, wherein the metal hydride buffer is configured to adsorb a hydrogen charge gas from the hydrogen source and desorb a hydrogen discharge gas to the anode; and a heat exchange loop in thermal communication with the metal hydride buffer, such that a change in temperature produced by adsorption of the hydrogen charge gas or desorption of the hydrogen discharge gas by the metal hydride buffer is thermally communicated to the heat exchange loop and transferred to a passenger compartment of the vehicle, thereby conditioning the air therein.

In another embodiment, a method for supplying hydrogen gas to a fuel cell system of a vehicle is provided, the method comprising: charging a metal hydride buffer with hydrogen gas from a hydrogen source at a pressure sufficient to enable adsorption of the hydrogen gas by the metal hydride buffer, thereby producing heat; transferring the heat from the adsorption of the hydrogen gas by the metal hydride buffer to a passenger compartment of the vehicle, thereby heating the passenger compartment; and providing hydrogen gas discharged from the metal hydride buffer to an anode of a fuel cell, thereby supplying hydrogen gas to the fuel cell system of the vehicle.

These and other objects, features, embodiments, and advantages will become apparent to those of ordinary skill in the art from a reading of the following detailed description and the appended claims.

### BRIEF DESCRIPTION OF THE DRAWINGS

FIG. 1 is a schematic diagram of a system for heating air in a passenger compartment of a fuel cell-powered vehicle, according to an embodiment of the present invention.

FIG. 2 is a schematic diagram of a system for heating air in a passenger compartment of a fuel cell-powered vehicle, according to an embodiment of the present invention.

FIG. 3 is a schematic diagram showing configurations A-D for fluidly connecting the metal hydride buffer and the heater core via an air loop and heat exchange loop.

FIG. 4 is a schematic diagram of a fuel cell-powered vehicle.

### DETAILED DESCRIPTION OF THE EMBODIMENTS

The following discussion of the embodiments of the invention directed to methods and systems for heating the passenger compartment of a fuel cell-powered vehicle are exemplary in nature and are not intended to limit the invention or the applications and uses thereof.

As used herein, the term “metal hydride buffer” refers to a solid metal alloy capable of reversibly adsorbing, storing, and desorbing hydrogen gas under pressure. Metal hydride buffers can adsorb and desorb hydrogen gas many times, without deterioration of the metal alloy.

Various buffer materials are suitable for use in the metal hydride buffer applications provided herein. In certain embodiments, the metal hydride buffer is comprised of a metal alloy selected from the group consisting of transition metals such as cobalt, nickel, copper, and zinc. In another embodiment, ferrous and lanthanum alloys are suitable for use in metal hydride buffer applications. In embodiments involving higher desorption temperatures, alloys of alanates such as natrium-aluminum-hydrides are suitable for use. The metal hydride buffer as described herein is a discrete component of the hydrogen powered vehicle, in addition to the hydrogen storage means.

Hydrogen adsorption and desorption (release) are chemical reactions with associated heats of formation which are exothermic (adsorption) and endothermic (desorption), respectively. The reaction is reversible and the direction of the reaction depends on the pressure of the system. Above the equilibrium pressure, the metal alloy adsorbs hydrogen to form a metal hydride; below the equilibrium pressure, the metal hydride releases hydrogen and returns to its original state. The equilibrium pressure depends upon the particular metal alloy employed, as well as the temperature of the system. The instant embodiments employ these endothermic and exothermic heats of formation to provide rapid conditioning of the air in a passenger compartment of a vehicle, without loss of hydrogen gas, as the hydrogen gas used to charge the metal hydride buffer is then cycled to the fuel cell to be used as fuel.

The instant embodiments allow rapid heating of the passenger compartment of a fuel cell-powered vehicle, during system warm-up and prior to reaching the operating temperature of the fuel cell system. The instant embodiments provide a smaller, lighter, cost-effective hydride system for rapid heating of the passenger compartment, which may be used alone or as an adjunct to a conventional heating or cooling system.

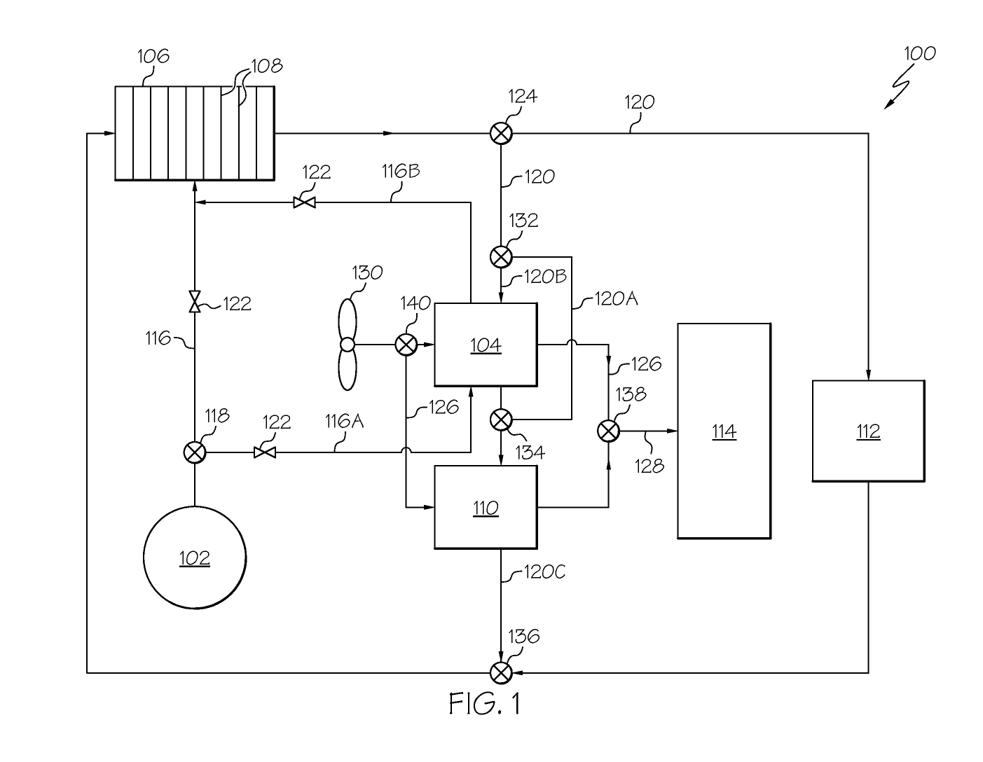

FIG. 1 is a schematic diagram of a system 100 for directly heating or cooling air in a passenger compartment 114 of a fuel cell-powered vehicle 10. According to the embodiment, the system 100 includes a hydrogen source 102 in fluid communication via fuel line 116 with a fuel cell stack 106, comprised of a plurality of fuel cells 108. Metal hydride buffer 104 is in fluid communication with the hydrogen source 102 via portions 116A and 116B of fuel line 116. A pressure regulator 122 provides hydrogen gas as a fuel to an anode of the fuel cell stack 106. A pressure regulator 122 controls the pressure of the hydrogen charge gas provided to the metal hydride buffer 104 through fuel line portion 116A, such that the hydrogen charge gas is provided to the metal hydride buffer 104 at a pressure sufficient to charge the metal hydride buffer 104, thereby causing the metal hydride buffer 104 to adsorb hydrogen charge gas, which produces heat. Once the metal hydride buffer 104 desorbs hydrogen discharge gas, hydrogen discharge gas is fed back to the anode of the fuel cell stack 106 through fuel line portion 116B. Another pressure regulator 122 controls the pressure of the hydrogen discharge gas provided to the fuel cell stack 106, while one or more valves 118 control the flow of hydrogen from the hydrogen source 102 to the metal hydride buffer 104 via fuel line portion 116A as well as to fuel cell stack 106 through fuel line 116.

Heat exchange loop 120 is in fluid communication with fuel cell stack 106 and the radiator 112. Heat produced by the fuel cell stack 106 is conducted to the radiator 112 via coolant in heat exchange loop 120. The radiator 112 cools the coolant in the loop 120 such that cooled coolant is returned to the fuel cell stack 106 via heat exchange loop 120.

In one embodiment, a valve 124 in heat exchange loop 120 permits selective flow of coolant from the fuel cell stack 106 to the metal hydride buffer 104 and/or heater core 110. In one embodiment, valve 132 selectively directs coolant flow through loop portion 120A, which bypasses the metal hydride buffer 104 and fluidly connects heat exchange loop 120 with heater core 110. Another valve 134 controls the flow of coolant from the bypass in loop portion 120A back to heat exchange loop 120. Loop portion 120C fluidly connects the heater core 110 with heat exchange loop 120 through valve 136. Valves 124 (diverter valve, installed on the supply line) and 136 (mixing valve, installed on the return line) are redundant valves, and in different embodiments, one or both of valves 124 and 136 may be present. Similarly, valves 132 (diverter valve) and 134 (mixing valve) are redundant valves and in different embodiments, one or both of valves 132 and 134 may be present.

In situations where it is desirable to thermally communicate heat from both the fuel cell stack 106 and the metal hydride buffer 104 to the heater core 110, valve 132 directs coolant flow through heat exchange loop portion 120B, whereby the metal hydride buffer 104 and heater core 110 are fluidly connected in series with heat exchange loop 120. As before, loop portion 120C fluidly connects the heater core 110 with heat exchange loop 120 through valve 136.

One skilled in the art will appreciate that heater core 110 contains all standard heat exchange features and electronic controls necessary to provide heating or cooling to the passenger compartment 114 at the request of the vehicle operator.

Air loop 126 provides air to the metal hydride buffer 104 and/or heater core 110. While the metal hydride buffer 104 and heater core 110 are depicted in the figure as fluidly connected in parallel, one skilled in the art will understand that serial fluid connection is an alternative embodiment that is also within the scope of the present invention. Valve 140 selectively directs the flow of air in air loop 126. In one embodiment, valve 140 operates such that air flow bypasses the metal hydride buffer 104 and is directed only to the heater core 110. In another embodiment, valve 140 permits air flow to both the metal hydride buffer 104 and the heater core 110 in parallel (if connected in parallel as shown) or serially, if connected in series (not shown). Air loop 126 feeds into line 128, which directs the flow of conditioned air to passenger compartment 114. Valve 138 selectively permits air from the heater core 110 and/or metal hydride buffer 104 to flow into the passenger compartment 114. Valves 138 and 140 are redundant valves, and in different embodiments, one or both of valves 138 (mixing valve installed on the return line) and 140 (diverter valve installed on the supply line) may be present.

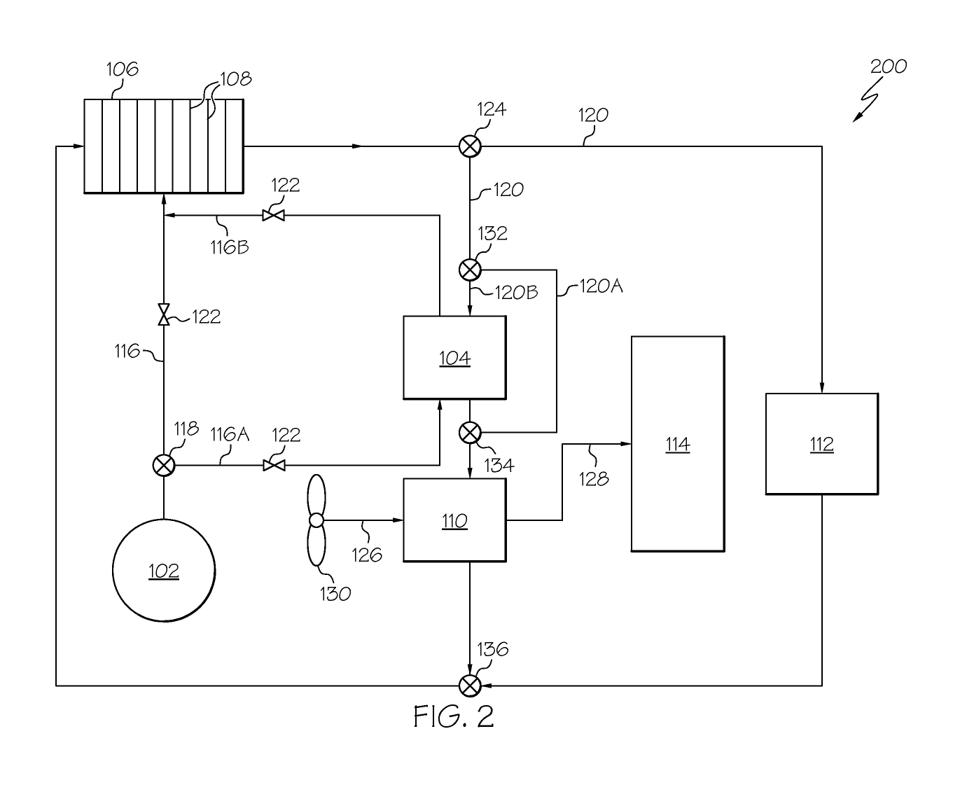

FIG. 2 is a schematic diagram of a system 200, wherein like parts are numbered in like manner. System 200 functions as System 100, but in place of valves to selectively direct the air flow to the heater core only, the system is configured such that the metal hydride buffer 104 is fluidly connected to the heater core 110 by way of heat exchange loop portion 120B, and heat from charging the metal hydride buffer 104 is transferred to the heater core 110 through the coolant in loop portion 120B, such that air in the passenger compartment 114 is conditioned indirectly via the heated coolant. Air is passed over the heater core 110 via air loop 126 and directed to the passenger compartment via line 128.

Systems 100 and 200 may receive fresh air from outside the vehicle, which is passed over the metal hydride buffer 104 and/or the heater core 110 through air loop 126, directed to the passenger compartment 114 through line 128, and then exhausted from the vehicle through the rear of the passenger compartment 114. Alternatively, line 128 can form a loop (not shown), whereby air from the passenger compartment 114 is recirculated back into the system via air loop 126.

In the simplest embodiment, heat, or a positive change in temperature, produced by the adsorption of hydrogen charge gas by the metal hydride buffer 104 is thermally communicated directly to the passenger compartment 114 by way of air circulating through air loop 126, which is in thermal communication with the metal hydride buffer 104 and the heater core 110. Line 128 receives conditioned air from air loop 126 and directs the conditioned air to the passenger compartment 114. The fan 130 operates to direct air flow through the air loop 126 and line 128, and may be positioned at any suitable location to effect movement of the heat from the metal hydride buffer 104 to the passenger compartment 114.

It is also appreciated that the process of discharging hydrogen discharge gas from the metal hydride buffer 104 results removal of heat from the system, or a negative change in temperature. Accordingly, in one embodiment, the negative change in temperature produced by the desorption of hydrogen discharge gas by the metal hydride buffer 104 can also be communicated directly to the passenger compartment 114 by way of air loop 126 and line 128 in order to cool the passenger compartment 114.

In another embodiment, heat produced by the adsorption of hydrogen charge gas by the metal hydride buffer 104 is transferred to coolant in heat exchange loop 120 and the heater core 110. In this embodiment, heater core 110 exchanges the heat from the coolant in heat exchange loop 120 to air and the heated air is then directed to the passenger compartment 114 at the request of the vehicle operator, via air loop 126 and line 128.

It is also appreciated that the process of discharging hydrogen discharge gas from the metal hydride buffer 104 results removal of heat from the system, or a negative change in temperature. Accordingly, in this embodiment, the negative change in temperature produced by the desorption of hydrogen discharge gas by the metal hydride buffer 104 can also be transferred to the passenger compartment 114 by way of heat exchange loop 120, air loop 126, and line 128 in order to cool the passenger compartment 114.

Significantly, the systems 100 and 200 discussed above are configured as an open-loop (rather than closed-loop) system. In an open-loop system, the metal hydride buffer is only an intermediate buffer for the hydrogen supplied from the main storage system to the fuel cell system using the high supply pressure for the adsorption process. The hydrogen is not used as a working fluid between two or more hydride beds in a closed loop application, which requires additional pumps to provide the necessary adsorption pressure. Moreover, because the pressure in the metal hydride buffer 104 is high enough (even after the desorption step) to feed the hydrogen to the fuel cell stack 106, no supplemental pump, compressor or related pressurizing device is required for fuel delivery; this can significantly simplify the configuration of the equipment used in delivery of fuel to the stack 106. Furthermore, the use of systems 100 and 200 of the present invention is generally not intended for normal operation of vehicle 10, but instead only during discrete periods (in general) and warm-up (in particular) where the need to deliver heat promptly to the passenger compartment 114 without consuming fuel or employing complex heating strategies is especially warranted.

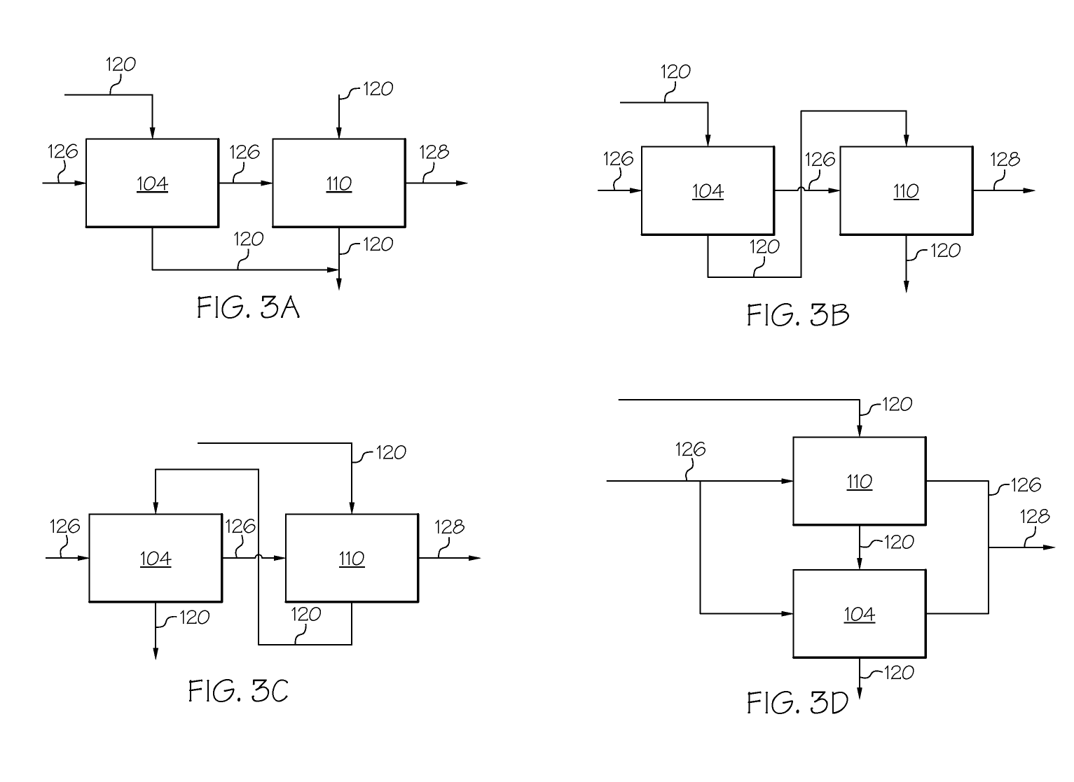

It is to be understood that the metal hydride buffer 104 and the heater core 110 of any of the systems disclosed herein can be connected in a variety of ways via the air loop 126 and heat exchange loop 120. For example, in FIG. 3A, the metal hydride buffer 104 and the heater core 110 are fluidly connected in parallel via heat exchange loop 120, and in series via air loop 126. In FIG. 3B, the metal hydride buffer 104 and the heater core 110 are fluidly connected in series via air loop 126 and heat exchange loop 120. FIG. 3C shows a configuration whereby the heater core 110 and metal hydride buffer 104 are fluidly connected in series via heat exchange loop 120 and air loop 126, but wherein the coolant first passes through the heater core 110 before passing through the metal hydride buffer 104. However, the skilled artisan would understand that the same configuration could be applied, wherein the coolant first passes through the metal hydride buffer 104 prior to passing through the heater core 110. FIG. 3D shows a configuration whereby the heater core 110 and the metal hydride buffer 104 are fluidly connected in parallel via air loop 126 and in series via heat exchange loop 120. The skilled artisan will understand that other configurations are also attainable, in series and in parallel, in order to facilitate heat exchange from the metal hydride buffer to the heater core and ultimately to the passenger compartment. Finally, the skilled artisan will understand that any of the configurations 3A-3D may contain valves for selectively directing the flow of air or coolant to one or both of the heater core 110 and the metal hydride buffer 104.

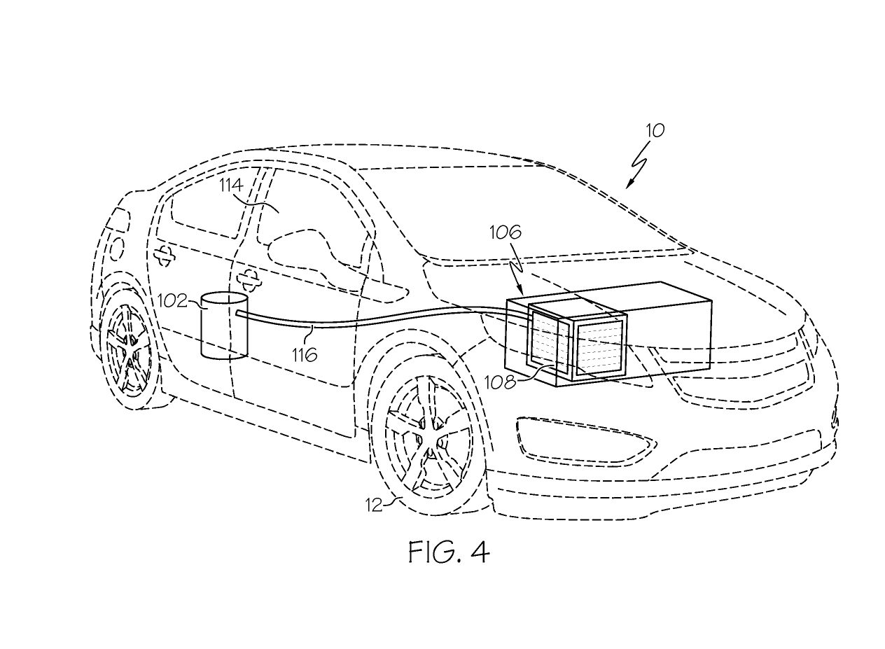

FIG. 4 is a schematic diagram of a fuel cell-powered vehicle 10, comprising a passenger compartment 114. As a source of motive power, the vehicle 10 comprises a fuel cell stack 106. Hydrogen source 102 provides hydrogen gas to an anode of the fuel cell stack 106 through fuel line 116. The fuel cell stack 106 is in fluid communication with a fuel supply system. The fuel cell stack 106 contributes to the turning of at least one wheel 12 of the vehicle 10. Vehicle 10 can comprise any of the systems and embodiments disclosed herein, including the system depicted in FIG. 1.

In another embodiment, a method for supplying hydrogen gas to a fuel cell system of a vehicle is provided, the method comprising: charging a metal hydride buffer with hydrogen gas from a hydrogen source at a pressure sufficient to enable adsorption of the hydrogen gas by the metal hydride buffer, thereby producing heat; transferring the heat from the adsorption of the hydrogen gas by the metal hydride buffer to a passenger compartment of the vehicle, thereby heating the passenger compartment; and providing hydrogen gas discharged from the metal hydride buffer to an anode of a fuel cell, thereby supplying hydrogen gas to the fuel cell system of the vehicle. In one embodiment, transferring heat to the passenger compartment comprises transferring the heat to a heat exchange loop. In another embodiment, the method further comprises transferring the heat from the heat exchange loop to a heater core. In still another embodiment, the method further comprises discharging hydrogen gas from the metal hydride buffer to the anode of a fuel cell at a pressure sufficient to power the fuel cell.

In another embodiment, a method for cooling a passenger compartment of a fuel cell-powered vehicle is provided, the method comprising: discharging a metal hydride buffer of a hydrogen gas at a pressure sufficient to enable desorption of the hydrogen gas by the metal hydride buffer, thereby producing a negative change in temperature; transferring the negative change in temperature from the desorption of the hydrogen gas by the metal hydride buffer to the passenger compartment, thereby cooling the passenger compartment, and providing hydrogen gas discharged from the metal hydride buffer to an anode of a fuel cell for use as fuel. In one embodiment, transferring the negative change in temperature to the passenger compartment comprises transferring the negative change in temperature to a heat exchange loop. In another embodiment, the method further comprises transferring the negative change in temperature from the heat exchange loop to a heater core.

One skilled in the art will also appreciate that a system utilizing off-heat from the adsorption of hydrogen gas by a metal hydride buffer is useful in heating a passenger compartment of any vehicle that employs hydrogen gas, regardless of whether the hydrogen gas is converted in a fuel cell or an internal combustion engine or if the fuel cell is used to power auxiliary or ancillary functions of the vehicle. Any vehicle that comprises a hydrogen gas source can employ the metal hydride buffer system disclosed herein in order to provide conditioned air to a passenger compartment of the vehicle.

While particular embodiments of the present invention have been illustrated and described, it would be obvious to one skilled in the art that various other changes and modifications can be made without departing from the spirit and scope of the invention. It is therefore intended to cover in the appended claims all such changes and modifications that are within the scope of this invention.

We claim:

1. A system for heating air in a passenger compartment of a fuel cell-powered vehicle, the system comprising:
a metal hydride buffer in fluid communication with a hydrogen source and an anode of a fuel cell, wherein the metal hydride buffer is configured to adsorb a hydrogen charge gas from the hydrogen source and desorb a hydrogen discharge gas to the anode; and
a heat exchange loop in thermal communication with the metal hydride buffer and the passenger compartment, whereby heat produced by adsorption of the hydrogen charge gas by the metal hydride buffer is thermally communicated to the heat exchange loop and transferred to the passenger compartment, thereby heating the air therein.

2. The system of claim 1, further comprising a heater core in thermal communication with the heat exchange loop, wherein the heat produced by adsorption of the hydrogen charge gas by the metal hydride buffer is thermally communicated from the heat exchange loop to the heater core.

3. The system of claim 1, further comprising a first pressure regulator for controlling pressure of the hydrogen charge gas delivered to the metal hydride buffer from the hydrogen source.

4. The system of claim 3, wherein the first pressure regulator provides hydrogen charge gas to the metal hydride buffer at a pressure sufficient to enable adsorption of the hydrogen charge gas, thereby producing heat.

5. The system of claim 1, further comprising a second pressure regulator for controlling pressure of the hydrogen discharge gas delivered to the anode from the metal hydride buffer.

6. The system of claim 5, wherein the hydrogen discharge gas is desorbed from the metal hydride buffer at a pressure sufficient to power the fuel cell.

7. A vehicle comprising:
a source of motive power comprising at least one fuel cell;
a fuel supply system coupled to the source of motive power such that operation of the fuel supply system contributes to the turning of at least one wheel of said vehicle through the source of motive power, the fuel supply system comprising:
a hydrogen source for providing a hydrogen charge gas;
a metal hydride buffer in fluid communication with the hydrogen source and an anode of the at least one fuel cell, wherein the metal hydride buffer is configured to adsorb a hydrogen charge gas from the hydrogen source and desorb a hydrogen discharge gas to the anode; and
a heat exchange loop in thermal communication with the metal hydride buffer, such that a change in temperature produced by adsorption of the hydrogen charge gas or desorption of the hydrogen discharge gas by the metal hydride buffer is thermally communicated to the heat exchange loop and transferred to a passenger compartment of the vehicle, thereby conditioning air therein.

8. The vehicle of claim 7, further comprising a heater core in thermal communication with the heat exchange loop, wherein the change in temperature produced by adsorption of the hydrogen charge gas or desorption of the hydrogen discharge gas by the metal hydride buffer is thermally communicated from the heat exchange loop to the heater core.

9. The vehicle of claim 7, further comprising a first pressure regulator for controlling pressure of the hydrogen charge gas delivered to the metal hydride buffer from the hydrogen source.

10. The vehicle of claim 9, wherein the first pressure regulator provides the hydrogen charge gas to the metal hydride buffer at a pressure sufficient to enable adsorption of the hydrogen charge gas by the metal hydride buffer, thereby producing a positive change in temperature.

11. The vehicle of claim 10, wherein the positive change in temperature is thermally communicated to the heat exchange loop and transferred to the passenger compartment, thereby heating the passenger compartment.

12. The vehicle of claim 11, wherein the hydrogen discharge gas is desorbed from the metal hydride buffer at a pressure sufficient to power the at least one fuel cell.

13. The vehicle of claim 12, further comprising a second pressure regulator for controlling pressure of the hydrogen discharge gas delivered to the anode from the metal hydride buffer.

14. The vehicle of claim 13, wherein the second pressure regulator provides hydrogen discharge gas to the anode at a pressure sufficient to enable desorption of the hydrogen discharge gas, thereby producing a negative change in temperature.

15. The vehicle of claim 14, wherein the negative change in temperature is thermally communicated to the heat exchange loop and transferred to the passenger compartment, thereby cooling the passenger compartment.

16. A method for supplying hydrogen gas to a fuel cell system of a vehicle, the method comprising:
charging a metal hydride buffer with hydrogen gas from a hydrogen source at a pressure sufficient to enable adsorption of the hydrogen gas by the metal hydride buffer, thereby producing heat;
transferring the heat from the adsorption of the hydrogen gas by the metal hydride buffer to a passenger compartment of the vehicle, thereby heating the passenger compartment; and
providing hydrogen gas discharged from the metal hydride buffer to an anode of a fuel cell, thereby supplying hydrogen gas to the fuel cell system of the vehicle.

17. The method of claim 16, wherein transferring heat to the passenger compartment comprises transferring the heat to a heat exchange loop.

18. The method of claim 17, further comprising transferring the heat from the heat exchange loop to a heater core.

19. The method of claim 16, wherein the hydrogen gas discharged from the metal hydride buffer is provided to the anode of a fuel cell at a pressure sufficient to power the fuel cell.
